(19) United States
(12) Patent Application Publication
(10) Pub. No.: US 2026/0128551 A1
(43) Pub. Date: May 7, 2026

(54) CONNECTOR POSITION ASSURANCE, POSITION-LIMIT MECHANISM THEREOF, AND CONNECTOR ASSEMBLY

(71) Applicant: Tyco Electronics (Shanghai) Co., Ltd., Shanghai (CN)

(72) Inventors: Shiyang (Sean) Tan, Wuhan (CN); Zhaowen Zhou, Shanghai (CN); Jianxiong (Jesse) Li, Shanghai (CN); Leilei (Haley) XU, Shanghai (CN)

(73) Assignee: Tyco Electronics (Shanghai) Co., Ltd., Shanghai (CN)

(21) Appl. No.: 19/382,673

(22) Filed: Nov. 7, 2025

(30) Foreign Application Priority Data
Nov. 7, 2024 (CN) 202422720115.X

(51) Int. Cl. H01R 13/627; H01R 13/44; H01R 13/50; H01R 13/635

(52) U.S. Cl. CPC H01R 13/6272; H01R 13/44; H01R 13/501; H01R 13/635

(57) ABSTRACT

A connector position assurance includes a base fixed on a connector, a flexible locking arm connected to the base, and a position-limit mechanism. The position-limit mechanism has a limiting base slidably connected with the base in an insertion direction of the connector, a locking position, and an unlocking position. A receiving space for receiving a locking part of a mated connector that mates with the connector is formed between the position-limit mechanism and the base. When the connector is inserted into the mated connector the flexible locking arm is located within the receiving space and engages with the locking part to lock the connector and the mated connector. The limiting base is formed with a pressing portion pressing the flexible locking arm downward to release an engagement between the flexible locking arm and the locking part of the mated connector when the position-limit mechanism is in the unlocking position.

### CROSS-REFERENCE TO RELATED APPLICATION

This application claims the benefit of the filing date under 35 U.S.C. § 119(a)-(d) of Chinese Patent Application No. 202422720115.X filed on Nov. 7, 2024, the whole disclosure of which is incorporated herein by reference.

### FIELD OF THE INVENTION

The present invention relates to a connector position assurance and, more particularly, to a connector position assurance, a position-limit mechanism for the connector position assurance, and a connector assembly including the connector position assurance.

### BACKGROUND OF THE INVENTION

A connector assembly typically includes a connector and a mated connector that are connected together, and a connector position assurance (CPA) that prevents separation between the connector and the mated connector. The connector position assurance usually includes a flexible locking arm, which is configured to be engaged with a locking part of the mated connector when the connector is inserted into the mated connector, so as to lock the connector and the mated connector. When unlocking, it is usually necessary to press the flexible locking arm with a finger to separate it from the locking part of the mated connector. However, since the finger directly contacts the flexible locking arm, it is easy for the finger to be cut by the flexible locking arm. Moreover, the flexible locking arm usually deforms after multiple presses, making it difficult to lock and unlock again. In addition, the space required for pressing the flexible locking arm is relatively large, which is not conducive to the miniaturization of the connector position assurance.

### SUMMARY OF THE INVENTION

A connector position assurance includes a base fixed on a connector, a flexible locking arm connected to the base, and a position-limit mechanism. The position-limit mechanism has a limiting base slidably connected with the base in an insertion direction of the connector, a locking position, and an unlocking position. A receiving space for receiving a locking part of a mated connector that mates with the connector is formed between the position-limit mechanism and the base. When the connector is inserted into the mated connector the flexible locking arm is located within the receiving space and engages with the locking part to lock the connector and the mated connector. The limiting base is formed with a pressing portion pressing the flexible locking arm downward to release an engagement between the flexible locking arm and the locking part of the mated connector when the position-limit mechanism is in the unlocking position.

### BRIEF DESCRIPTION OF DRAWINGS

The invention will now be described by way of example with reference to the accompanying figures, of which:

FIG. 1 is a perspective view of a connector assembly according to an exemplary embodiment;

FIG. 2 is a perspective view of the connector assembly of FIG. 1 before assembling;

FIG. 3 is a partial sectional view of the connector assembly of FIG. 1, where a position-limit mechanism of a connector position assurance is in an unlocking position;

FIG. 4 is a partial sectional view of the connector assembly of FIG. 1, where the position-limit mechanism of FIG. 3 is in a locking position;

FIG. 5 is a partial sectional view of the connector assembly of FIG. 1, where the position-limit mechanism of FIG. 3 is in an unlocking position and a pressing portion of the position-limit mechanism is in a pressed condition; and

FIG. 6 is a partial schematic view of the connector assembly of FIG. 1, where the connector position assurance of FIG. 3 is shown from another perspective.

### DETAILED DESCRIPTION

Although the present disclosure will be fully described with reference to the drawings containing embodiments of the present disclosure, it should be understood that those skilled in the art may modify the present disclosure described herein and obtain the technical effect of the present disclosure. Therefore, it is necessary to understand that the description is a broad disclosure for those skilled in the art and is not intended to limit the exemplary embodiments described in the present disclosure.

In addition, in the following detailed description, for the sake of explanation, numerous specific details are set forth in order to provide a thorough understanding of the disclosed embodiments. It will be apparent, however, that one or more embodiments may also be practiced without these specific details. In other instances, well-known structures and devices are illustrated schematically in order to simplify the drawing.

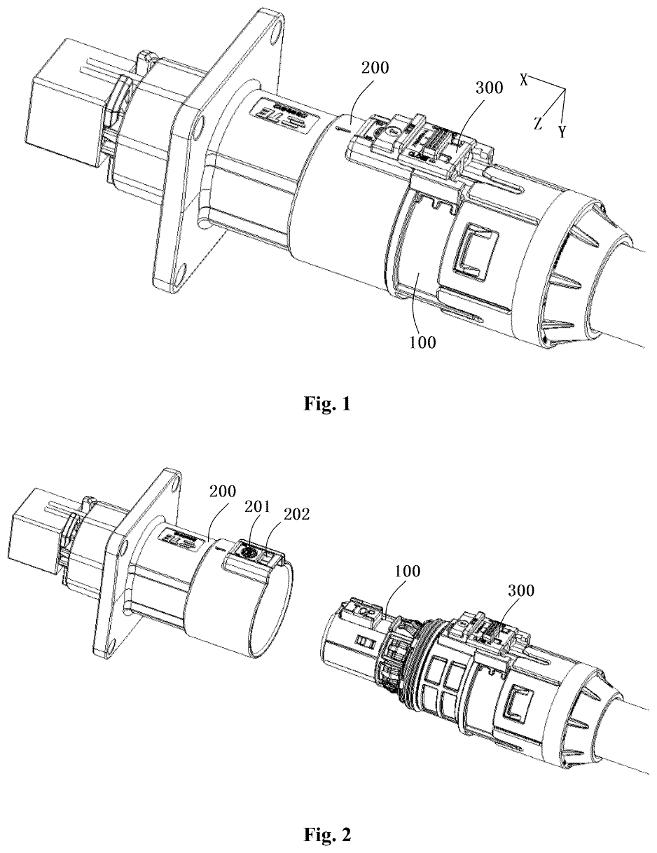

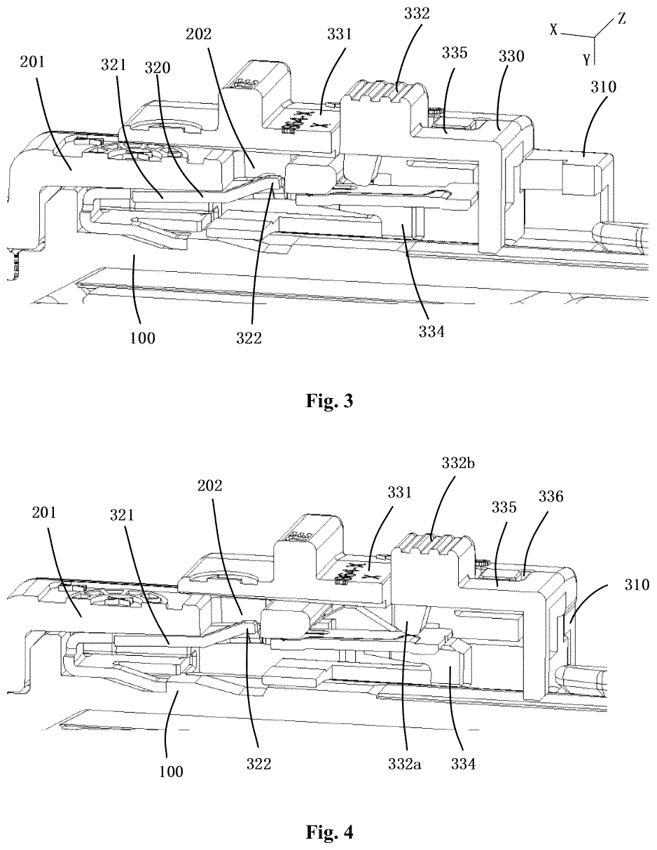

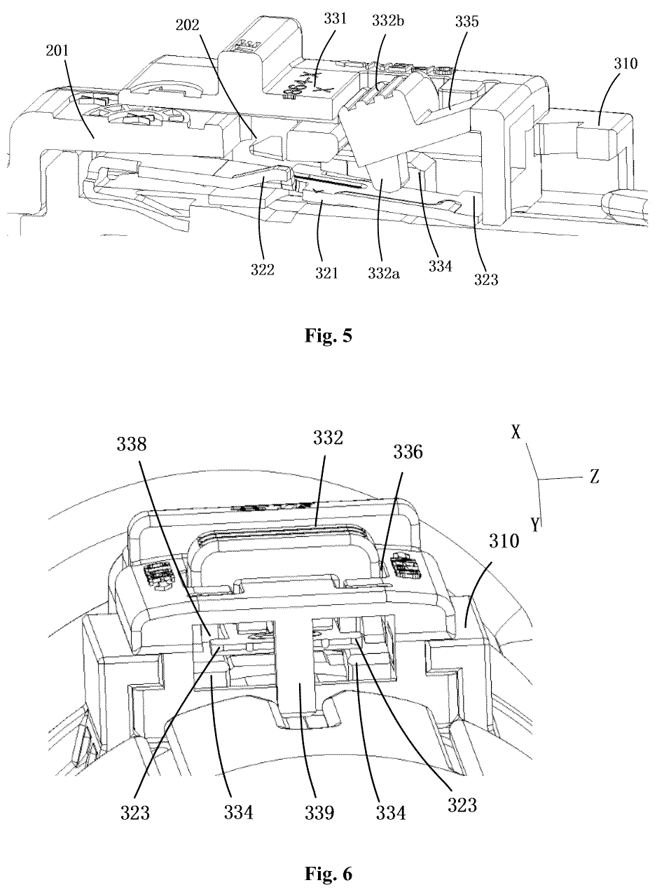

An exemplary embodiment of a connector position assurance 300 will now be described with reference to FIGS. 1-6. The connector position assurance 300 includes a base 310, as shown in FIGS. 3-6, fixed on a connector 100, a flexible locking arm 320, as shown in FIG. 3, connected to the base 310, and a position-limit mechanism 330, as shown in FIG. 3. A receiving space for receiving a locking part 201 of a mated connector 200 that mates with the connector 100 is formed between the position-limit mechanism 330 and the base 310. The flexible locking arm 320, as shown in FIG. 3, is located within the receiving space, and the flexible locking arm 320 is configured to be engaged with the locking part 201 of the mated connector 200 when the connector 100 is inserted into the mated connector 200, so as to lock the connector 100 and the mated connector 200. The position-limit mechanism 330 includes a limiting base 331, as shown in FIGS. 3-5, slidably connected with the base 310 in an insertion direction X of the connector 100. The position-limit mechanism 330 has a locking position (as shown in FIG. 4) and an unlocking position (as shown in FIGS. 3 and 5), and the limiting base 331 is formed with a pressing portion 332, as shown in FIGS. 3 and 6, configured to press downward the flexible locking arm 320 so as to disengage the flexible locking arm 320 from the locking part 201 of the mated connector 200, when the position-limit mechanism 330 is in the unlocking position.

According to embodiments of the present disclosure, with provision of the pressing portion 332 on the position-limit mechanism 330, it is easy to press the flexible locking arm 320 from an outside with a finger via the pressing portion 330, which facilitates the operator to operate with a finger, and also can prevent direct touch of the finger with the flexible locking arm 320 so as to avoid being cut by the flexible locking arm 320. In addition, there is no need to provide a space for the finger to enter the receiving space in order to press the flexible locking arm 320, which is conducive to the miniaturization of the connector position assurance 300.

As shown in FIGS. 3 and 5, the flexible locking arm 320 includes a locking arm body 321 and a locking protrusion 322 protruding from an approximately middle of the locking arm body 321 in the insertion direction X of the connector 100. The locking part 201 of the mated connector 200 is formed with a locking hole 202, as shown in FIGS. 2-5, the locking protrusion 322 being configured to be clamped into a locking hole 202 of the locking part 201 of the mated connector 200 so as to lock the connector 100 and the mated connector 200. It should be noted that in some other embodiments of the present disclosure, the locking protrusion 322 of the flexible locking arm 320 may also be in the form of a shrapnel. Further, in some other embodiments of the present disclosure, the locking protrusion 322 of the flexible locking arm 320 may also be in the form of a locking hole; accordingly, the locking part 201 of the mated connector 200 is formed in the form of a locking protrusion or a locking sheet that is mated with the locking hole. Furthermore, although in this embodiment the locking protrusion 322, as shown in FIGS. 3 and 5, is approximately in the middle of the flexible locking arm 320, it is not limited thereto in the present disclosure, that is, the position of the locking protrusion 322 can be designed according to a specific context.

As shown in FIG. 3, a first end of the flexible locking arm 320 close to the mated connector 200 is fixed on the base 310. The pressing portion 332 is configured to press a portion of the flexible locking arm 320 close to the locking protrusion 322 when the position-limit mechanism 330 is in the unlocking position. In this way, the locking protrusion 322 of the flexible locking arm 320 can be disengaged from the locking hole 202 of the mated connector 200 by pressing with a smaller amplitude. At the same time, it can reduce or avoid the deformation of the flexible locking arm 320, so as to facilitate subsequent locking and unlocking. However, it should be noted that in some other embodiments of the present disclosure, the pressing portion 332 can also be configured to press other positions of the flexible locking arm 320 when the position-limit mechanism 330 is in the unlocking position, for example, a free end of the flexible locking arm 320, etc.

As shown in FIG. 3-6, the position-limit mechanism 330 further includes a support portion 334. The support portion 334 is connected to the limiting base 331 and configured to support a free end of the flexible locking arm 320 (namely a second end of the flexible locking arm 320 opposite to the first end) when the position-limit mechanism 330 is in the locking position. In this way, when the position-limit mechanism 330 is in the locking position, even if the pressing portion 332 is accidentally pressed, the flexible locking arm 320 will not displace since the free end of the flexible locking arm 320 is supported by the support portion 334, and it is thus impossible to disengage the locking protrusion 322 from the locking hole 202 of the mated connector 200.

In this embodiment, as shown in FIGS. 5-6, the flexible locking arm 320 further includes an extension portion 323 extended from the free end of the flexible locking arm 320 in the plane where the locking arm body 321 is located (namely the XZ plane shown in FIG. 6) and perpendicular to the insertion direction X. The support portion 334 is configured to support the extension portion 323 of the flexible locking arm 320 when the position-limit mechanism 330 is in the locking position. In this embodiment, as shown in FIG. 6, two support portions 334 and two extension portions 323 integrally formed from opposite sides of the limiting base 331, respectively, are shown. It should be noted that in some other embodiments of the present disclosure, only one extension portion 323 and one corresponding support portion 334 may be provided.

As shown in FIG. 3, the pressing portion 332 is connected to one end of the limiting base 331 away from the mated connector 200 via a connecting portion 335. Opposite sides of the pressing portion 332 and the connecting portion 335 in a direction Z perpendicular to the insertion direction X and one side of the pressing portion 332 away from the connecting portion 335 are separated from the limiting base 331 by a recess 336. As shown in FIG. 3, the pressing portion 332 and the connecting portion 335 are in the form of a T shape in the plane parallel to the insertion direction X of the connector 100 (namely, in the XZ direction in FIG. 6).

As shown in FIGS. 4-5, the pressing portion 332 includes a pressing body 332a protruding into the receiving space and an operating portion 332b protruding from the pressing body 332a beyond a top of the limiting base 331. A pattern is formed on the operating portion 332b to prevent sliding when a finger is pressed on the operating portion 332b. The pressing body 332a protrudes into the receiving space, so that pressing with a smaller amplitude can make the pressing body 332a to abut against the flexible locking arm 320.

The position-limit mechanism 330 is integrally formed, for example, by molding, and accordingly an opening 338, as shown in FIG. 6, is formed in one end of the limiting base 331 away from the mated connector 200. Accordingly, as shown in FIG. 6, in order to prevent a tool from entering the receiving space from the opening 338 to release the engagement between the flexible locking arm 320 and the locking part 201 of the mated connector 200, the position-limit mechanism 330 is formed with a blocking portion 339 at the opening 338.

As shown in FIG. 2, the base 310 of the connector position assurance 300 is integrally formed with the housing of the connector 100. It should be noted that in some other embodiments of the present disclosure, the base 310 of the connector position assurance 300 and the housing of the connector 100 can also be two separately formed components.

When in use, first, the connector 100 is inserted into the mated connector 200 along the insertion direction X. When the mated connector 200 is properly inserted into the connector 100, the connector position assurance 300 is in an initial state. As shown in FIG. 3, the locking hole 202 of the locking part 201 of the mated connector 200 is engaged with the locking protrusion 322 of the flexible locking arm 320 of the connector position assurance 300 to lock the mated connector 200 with the connector 100. Then, the position-limit mechanism 330 of the connector position assurance 300 is pushed in the direction opposite to the insertion direction X of the connector 100, so that the position-limit mechanism 330 is in its locking position, as shown in FIG. 4. The extension portion 323 at the free end of the flexible locking arm 320 is supported by the support portion 334 of the position-limit mechanism 330, to prevent the pressing portion 332 of the flexible locking arm 320 from disengaging from the locking hole 202 of the locking part 201 of the mated connector 200 due to accidental pressing of the pressing portion 332.

When it is desired to unlock the mated connector 200 from the connector 100, the position-limit mechanism 330 is pushed along the insertion direction X of the connector 100 into the unlocking position (as shown in FIG. 3). Here, the pressing portion 332 of the position-limit mechanism 330 is pressed with a finger to apply a force to the flexible locking arm 320 (as shown in FIG. 5). This force disengages the locking protrusion 322 of the flexible locking arm 320 from the locking hole 202 of the locking part 201 of the mated connector 200, and thereby completes the unlocking of the mated connector 200 from the connector 100.

According to another aspect of the present disclosure, there is also provided a position-limit mechanism 330 for a connector position assurance 300. In particular, the connector position assurance 300 includes a base 310 fixed on a connector 100 and a flexible locking arm 320 connected to the base 310. The flexible locking arm 320 is configured to be engaged with a locking part 201 of a mated connector 200 when the connector 100 is inserted into the mated connector 200, so as to lock the connector 100 and the mated connector 200. The position-limit mechanism 330 adopts the abovementioned position-limit mechanism 330. In particular, the position-limit mechanism 330 includes a limiting base 331 slidably connected with the base 310 of the connector position assurance 300, the position-limit mechanism 330 has a locking position and an unlocking position, and the limiting base 331 is formed with a pressing portion 332 configured to press downward the flexible locking arm 320 so as to release an engagement between the flexible locking arm 320 and the locking part 201 of the mated connector 200 when the position-limit mechanism 330 is in the unlocking position.

According to yet another aspect of the present disclosure, there is also provided a connector assembly including a connector 100 and a mated connector 200 mated with the connector 100, and the connector assembly further includes the abovementioned connector position assurance 300.

In the connector position assurance 300, the position-limit mechanism 330 thereof and the connector assembly provided by the various abovementioned embodiments of the present disclosure, with provision of the pressing portion 332 on the position-limit mechanism 330, it is easy to press the flexible locking arm 320 from an outside with a finger via the pressing portion 332, which facilitates the operator to operate with a finger, and also can prevent the touch of the finger with the flexible locking arm 320 so as to avoid being cut by the flexible locking arm 320. In addition, there is no need to provide a space for the finger to enter the receiving space to press the flexible locking arm 320, which is conducive to the miniaturization of the connector position assurance 300. In addition, with provision of the blocking portion 339 at the opening 338 of the position-limit mechanism 330, a tool is prevented from entering the receiving space from the opening 338 to release the engagement between the flexible locking arm 320 and the locking part 201 of the mated connector 200.

It should be appreciated by those skilled in the art that the above embodiments are intended to be illustrative, and many modifications may be made to the above embodiments by those skilled in the art. Further, various structures described in various embodiments may be freely combined with each other without conflicting in configuration or principle.

Although the present disclosure has been described hereinbefore in detail with reference to the accompanying drawings, it should be appreciated that the disclosed embodiments in the accompanying drawings are intended to illustrate the embodiments of the present disclosure by way of example, and should not be construed as a limitation to the present disclosure.

Although some embodiments of the general inventive concept of the present disclosure have been shown and described, it would be appreciated by those skilled in the art that changes or modifications may be made to these embodiments without departing from the principles and spirit of the general inventive concept, the scope of which is defined in claims and their equivalents.

It should be noted that, the word “comprise” or “include” doesn't exclude other elements or steps, and the word “a” or “an” doesn't exclude more than a plurality. In addition, any reference numerals in the claims should not be interpreted as the limitation to the scope of the present disclosure.

1. A connector position assurance, comprising:
a base fixed on a connector;
a flexible locking arm connected to the base; and
a position-limit mechanism having a limiting base slidably connected with the base in an insertion direction of the connector, a locking position, and an unlocking position, a receiving space for receiving a locking part of a mated connector that mates with the connector is formed between the position-limit mechanism and the base, when the connector is inserted into the mated connector the flexible locking arm is located within the receiving space and engages with the locking part to lock the connector and the mated connector, the limiting base is formed with a pressing portion pressing the flexible locking arm downward to release an engagement between the flexible locking arm and the locking part of the mated connector when the position-limit mechanism is in the unlocking position.

2. The connector position assurance of claim 1, wherein the flexible locking arm has a locking arm body and a locking protrusion protruding from a middle of the locking arm body in the insertion direction, the locking part of the mated connector is formed with a locking hole, the locking protrusion is clamped into the locking hole to lock the connector and the mated connector.

3. The connector position assurance of claim 2, wherein a first end of the flexible locking arm adjacent to the mated connector is fixed on the base, the pressing portion presses a portion of the flexible locking arm adjacent to the locking protrusion when the position-limit mechanism is in the unlocking position.

4. The connector position assurance of claim 3, wherein the position-limit mechanism has a support portion connected to the limiting base, the support portion supports a second end of the flexible locking arm opposite to the first end of the flexible locking arm when the position-limit mechanism is in the locking position.

5. The connector position assurance of claim 4, wherein the flexible locking arm has an extension portion extended from the second end of the flexible locking arm in a plane where the locking arm body is located and perpendicular to the insertion direction, the support portion supports the extension portion of the flexible locking arm when the position-limit mechanism is in the locking position.

6. The connector position assurance of claim 1, wherein the pressing portion is connected to one end of the limiting base away from the mated connector via a connecting portion, opposite sides of the pressing portion and the connecting portion in a direction perpendicular to the insertion direction and one side of the pressing portion away from the connecting portion are separated from the limiting base by a recess.

7. The connector position assurance of claim 1, wherein the position-limit mechanism is integrally formed, and an opening is formed in one end of the limiting base away from the mated connector.

8. The connector position assurance of claim 7, wherein the position-limit mechanism is formed with a blocking portion at the opening, the blocking portion prevents a tool from entering the receiving space to release the engagement between the flexible locking arm and the locking part of the mated connector.

9. The connector position assurance of claim 1, wherein the pressing portion has a pressing body protruding into the receiving space.

10. The connector position assurance of claim 9, wherein the pressing portion has an operating portion protruding from the pressing body beyond a top of the limiting base.

11. A position-limit mechanism for a connector position assurance, comprising:
a limiting base slidably connected with a base of the connector position assurance in an insertion direction of a connector, the position-limit mechanism has a locking position and an unlocking position, the limiting base is formed with a pressing portion, the base of the connector position assurance is fixed on the connector, a first end of a flexible locking arm of the connector position assurance is connected to the base, the flexible locking arm is engaged with a locking part of a mated connector when the connector is inserted into the mated connector to lock the connector and the mated connector, the pressing portion presses the flexible locking arm downward to release an engagement between the flexible locking arm and the locking part of the mated connector when the position-limit mechanism is in the unlocking position.

12. The position-limit mechanism of claim 11, wherein the pressing portion presses a portion of the flexible locking arm adjacent to a locking protrusion of the flexible locking arm when the position-limit mechanism is in the unlocking position.

13. The position-limit mechanism of claim 11, wherein the position-limit mechanism has a support portion connected to the limiting base, and the flexible locking arm has an extension portion extended from a second end of the flexible locking arm opposite to the first end of the flexible locking arm in a plane where a locking arm body of the flexible locking arm is located and perpendicular to the insertion direction, the support portion supports the extension portion of the flexible locking arm when the position-limit mechanism is in the locking position.

14. The position-limit mechanism of claim 11, wherein the pressing portion is connected to one end of the limiting base away from the mated connector via a connecting portion, opposite sides of the pressing portion and the connecting portion in a direction perpendicular to the insertion direction and one side of the pressing portion away from the connecting portion are separated from the limiting base by a recess.

15. The position-limit mechanism of claim 11, wherein the position-limit mechanism is integrally formed, and an opening is formed in one end of the limiting base away from the mated connector.

16. The position-limit mechanism of claim 15, wherein a blocking portion is formed at the opening, the blocking portion prevents a tool from entering a receiving space to release the engagement between the flexible locking arm and the locking part of the mated connector.

17. The position-limit mechanism of claim 11, wherein the pressing portion has a pressing body protruding into a receiving space.

18. The position-limit mechanism of claim 17, wherein the pressing portion has an operating portion protruding from the pressing body beyond a top of the limiting base.

19. A connector assembly, comprising:
a connector;
a mated connector mated with the connector; and
a connector position assurance including a base fixed on the connector, a flexible locking arm connected to the base, and a position-limit mechanism, the position-limit mechanism has a limiting base slidably connected with the base in an insertion direction of the connector, a locking position, and an unlocking position, a receiving space for receiving a locking part of the mated connector is formed between the position-limit mechanism and the base, when the connector is inserted into the mated connector the flexible locking arm is located within the receiving space and engages with the locking part to lock the connector and the mated connector, the limiting base is formed with a pressing portion pressing the flexible locking arm downward to release an engagement between the flexible locking arm and the locking part of the mated connector when the position-limit mechanism is in the unlocking position.
